(19) United States
(12) Patent Application Publication
(10) Pub. No.: US 2009/0311029 A1
(43) Pub. Date: Dec. 17, 2009

(54) LIQUID DISPENSER ASSEMBLY

(76) Inventor: Ron T. Guttmann, Kfar Saba (IL)

Correspondence Address: DARBY & DARBY P.C., P.O. BOX 770, Church Street Station, New York, NY, 10008-0770, US

(21) Appl. No.: 12/140,761

(22) Filed: Jun. 17, 2008

(51) Int. Cl. B05C 21/00; B67D 5/06; A47L 13/30; A47L 1/08

(52) U.S. Cl. 401/139; 222/380; 401/137

(57) ABSTRACT

A dispenser including a container portion and a dispensing and frictional engagement assembly, arranged for sealing engagement with the container portion, the dispensing and frictional engagement assembly including a resilient, flexible washing engagement portion and a manually controllable dispensing outlet assembly arranged to dispense a liquid from the container portion at a location spaced from the resilient flexible washing engagement portion, the resilient flexible washing engagement portion being isolated from the interior of the container portion whereby backflow of liquid from the flexible washing engagement portion normally is prevented from entering the interior of the container portion.

### FIELD OF THE INVENTION

The present invention relates to dispensers for liquid soap, shower gel and similar liquid products.

### BACKGROUND OF THE INVENTION

The following patent publications are believed to represent the current state of die art:

U.S. Pat. Nos. 6,983,866; 6,623,201; 6,425,701; 5,931,591; 5,871,297 and 5,454,659;

U.S. Published Patent Application Nos. 2006/0168746 and 2005/0066996.

### SUMMARY OF THE INVENTION

The present invention seeks to provide an innovative dispenser for liquid soap, shower gel and similar liquid products.

There is thus provided in accordance with a preferred embodiment of the present invention, a dispenser including a container portion and a dispensing and frictional engagement assembly, arranged for sealing engagement with the container portion, the dispensing and frictional engagement assembly including a resilient, flexible washing engagement portion and a manually controllable dispensing outlet assembly arranged to dispense a liquid from the container portion at a location spaced from the resilient flexible washing engagement portion, the resilient flexible washing engagement portion being isolated from the interior of the container portion whereby backflow of liquid from the flexible washing engagement portion normally is prevented from entering the interior of the container portion.

Preferably, the dispensing outlet assembly is configured and located such that liquid dispensed therefrom does not directly impinge on the flexible washing engagement portion.

In accordance with a preferred embodiment of the present invention the dispensing outlet assembly includes a selectably directable dispensing outlet assembly. Additionally, the dispensing outlet assembly includes a manually-controllable valve.

Preferably, the dispensing and frictional engagement assembly includes a dispensing portion and a frictional engagement portion.

In accordance with a preferred embodiment of the present invention the dispensing portion includes a first connector portion arranged for fixed, sealing engagement with the container portion following automated filling thereof and a second connection portion arranged for removable and replaceable engagement with the frictional engagement portion, the first and second connection portions not being in fluid communication with each other. Additionally, the dispensing portion includes the manually controllable dispensing outlet assembly and the frictional engagement portion includes the resilient, flexible washing engagement portion.

Preferably, the frictional engagement portion includes a resilient mounting surface.

Preferably, the dispensing and frictional engagement assembly includes a neck section having an engagement portion arranged for the removable and replaceable sealing engagement with the container portion and a forward mounting portion for mounting thereon of the resilient, flexible washing engagement portion, the manually controllable dispensing outlet assembly being disposed along the neck section intermediate the engagement portion and the forward mounting portion. Additionally, the forward mounting portion extends generally perpendicular to the longitudinal axis of the neck portion.

In accordance with a preferred embodiment of the present invention the manually controllable dispensing outlet assembly is arranged to as to dispense the liquid in a direction generally perpendicular to a longitudinal axis of the neck portion.

Preferably, the manually controllable dispensing outlet assembly is operative to permit manual control of opening and closing the outlet as well as manual control of the rate of dispensing the liquid.

In accordance with a preferred embodiment of the present invention the container portion includes a bottom wall portion and first and second generally upstanding container wall portions extending upwardly from the bottom wall portion, the first container wall portion having a first wall thickness and the second container wall portion having a second wall thickness different from the first wall thickness. Additionally, the first container wall portion extends alongside the second wall portion, generally perpendicularly to the bottom wall portion. Additionally or alternatively, the first container wall portion extends alongside a dorsal surface of the container portion and the second container wall portion extends along a ventral surface of the container portion and the first wall thickness is less than the second wall thickness.

There is also provided in accordance with another preferred embodiment of the present invention a dispenser assembly including a container portion including a bottom wall portion and first and second generally upstanding container wall portions extending upwardly from the bottom wall portion, the first container wall portion having a first wall thickness and the second container wall portion having a second wall thickness different from the first wall thickness and a dispensing portion, arranged for engagement with the container portion.

Preferably, the first container wall portion extends alongside the second wall portion, generally perpendicularly to the bottom wall portion.

In accordance with a preferred embodiment of the present invention the first container wall portion extends alongside a dorsal surface of the container portion and the second container wall portion extends along a ventral surface of the container portion and the first wall thickness is less than the second wall thickness.

There is further provided in accordance with yet another preferred embodiment of the present invention a dishwashing utensil including a container portion and a dispensing and frictional engagement assembly, arranged for sealing engagement with the container portion, the dispensing and frictional engagement assembly including a resilient, flexible dishwashing engagement portion and a manually controllable dispensing outlet assembly arranged to dispense a liquid from the container portion at a location spaced from the resilient flexible washing engagement portion, the resilient flexible washing engagement portion being isolated from the interior of the container portion whereby backflow of liquid from the flexible washing engagement portion normally is prevented from entering the interior of the container portion.

Preferably, the dispensing outlet assembly is configured and located such that liquid dispensed therefrom is directed onto an item while it is being washingly engaged by the resilient, flexible dishwashing engagement portion. Additionally or alternatively, the dispensing outlet assembly includes a selectably directable dispensing outlet assembly.

### BRIEF DESCRIPTION OF THE DRAWINGS

The present invention will be appreciated more fully from tile following detailed description, taken in conjunction with the drawings in which:

FIG. 1 and FIG. 2 are simplified respective exploded view and assembled view pictorial illustrations of a dispenser assembly constructed and operative in accordance with a preferred embodiment of the present invention;

FIG. 3 and FIG. 4 are simplified respective exploded view and assembled view sectional illustrations of the dispenser assembly of FIGS. 1 and 2 respectively;

FIGS. 5A and 5B are simplified illustrations of the operation of the dispenser assembly of FIGS. 1-4 in respective open and closed operative orientations;

FIGS. 6A and 6B are simplified pictorial illustrations of a use of the dispenser assembly of FIGS. 1-5B;

FIG. 7 is a simplified pictorial illustration of another use of the dispenser assembly of FIGS. 1-5B;

FIG. 8A and 8B are pictorial illustrations of a dispenser assembly constructed and operative in accordance with an alternative embodiment of the present invention;

FIGS. 9A and 9B are simplified illustrations of use of the dispenser assembly of FIGS. 8A and 8B;

FIGS. 10A, 10B and 10C are simplified illustrations of use of the dispenser assembly of FIGS. 8A and 8B; and

FIGS. 11A, 11B and 11C are simplified illustrations of a selectably directable dispensing valve useful in the dispenser assemblies of FIGS. 1-10C, in various open and closed operative orientations.

### DETAILED DESCRIPTION OF PREFERRED EMBODIMENTS

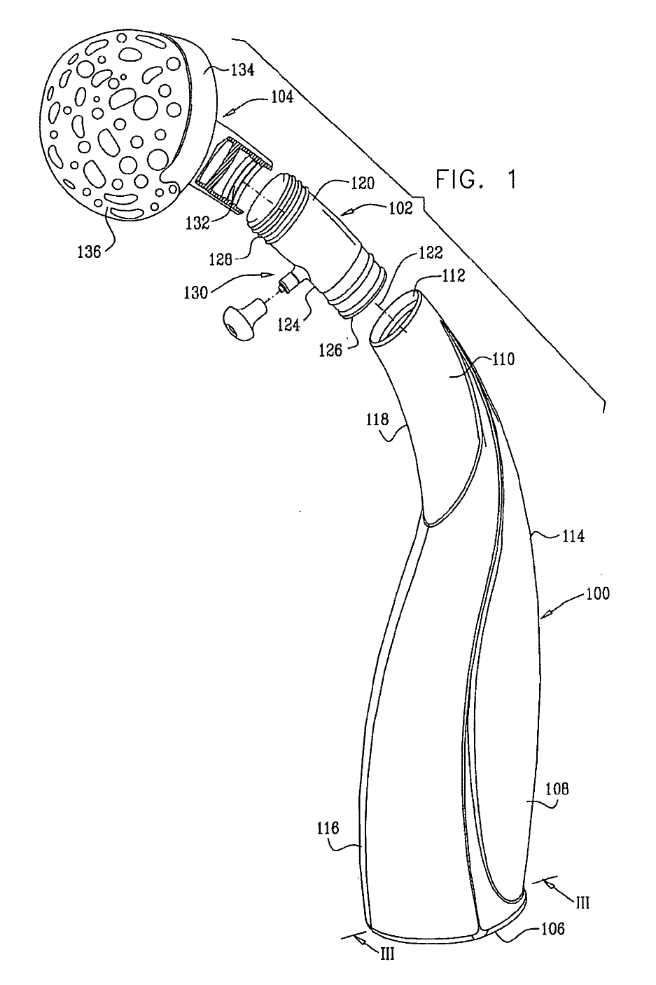

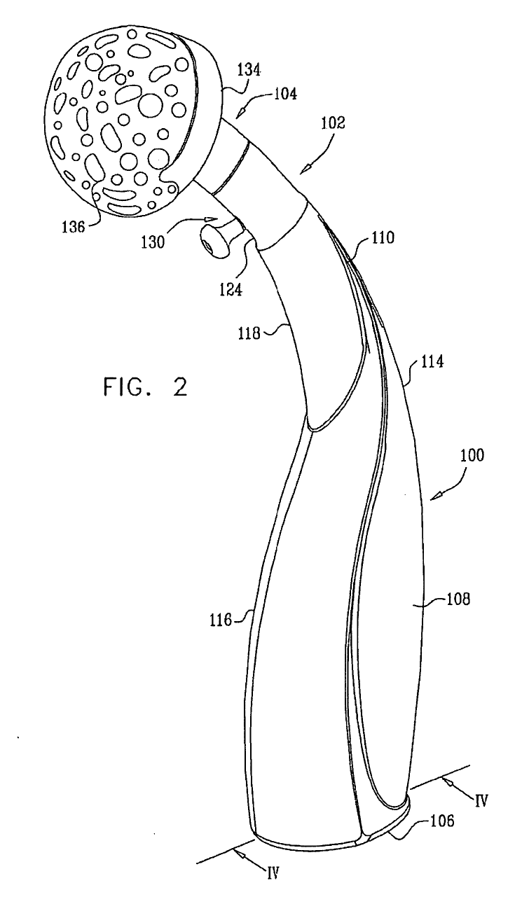

Reference is now made to FIGS. 1-7, which are simplified illustrations of a dispenser assembly constructed and operative in accordance with a preferred embodiment of the present invention. As seen in FIGS. 1-7, the dispenser assembly comprises a container portion 100, a dispensing portion 102 and a frictional engagement portion 104.

The container portion 100 is preferably formed with a flat bottom wall 106. Container portion 100 is generally upstanding and non-symmetric, having a main portion 108 extending upwardly from bottom wall 106 and terminating in a throat portion 110 having an opening 112 configured for sealing engagement with the dispensing portion 102 after filling of main portion 108 with liquid soap, shower gel or any other suitable material.

Main portion 108 and throat portion 110 preferably are configured to have a generally convex dorsal surface 114 which extends along both main portion 108 and throat portion 110, generally from bottom wall 106 to opening 112. Main portion 108 has a generally convex ventral surface 116, which extends generally from bottom wall 106 to throat portion 110. A ventral surface 118 of throat portion 110 has a generally concave curvature extending from the main portion 108 to opening 112. Opening 112 is preferably configured for ease of automated filling with a liquid such as liquid soap, shower gel or any other suitable material, and subsequent sealing engagement with dispensing portion 102.

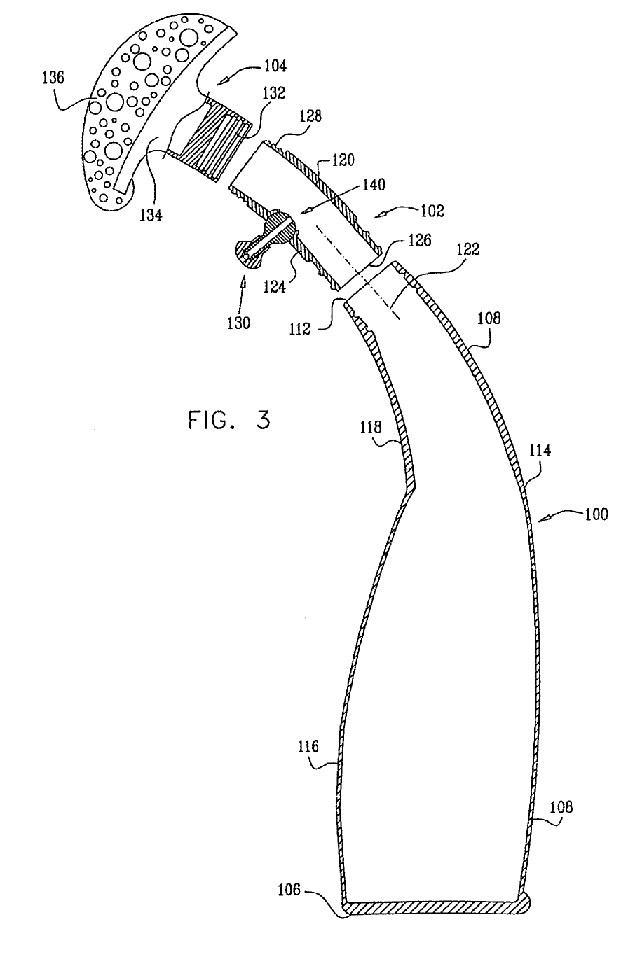

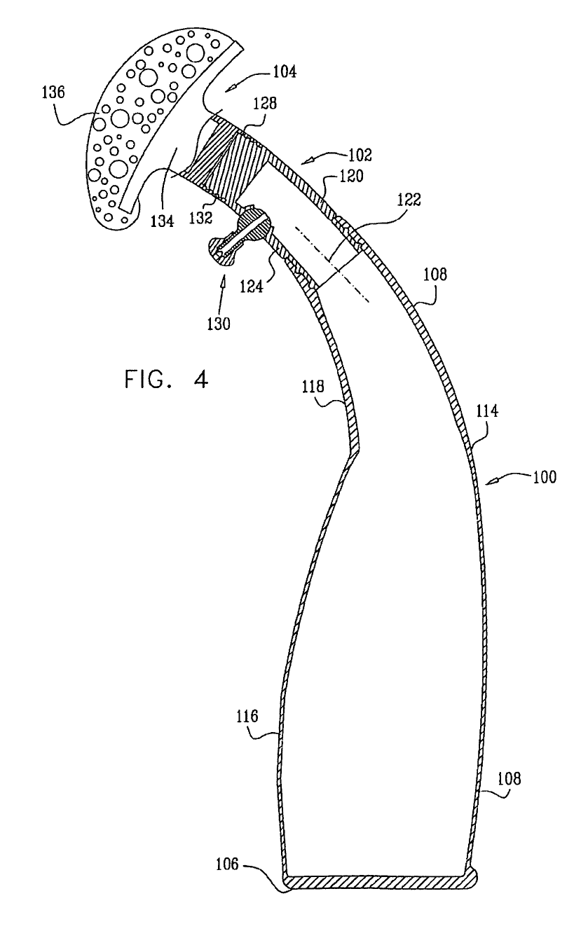

The dispensing portion 102 is configured to have a generally elongated throat portion 120 which is arranged about a longitudinal axis 122. More precisely, throat portion 120 may be formed with a slight forward curvature, including a generally concave ventral surface 124 which continues the curvature of the ventral surface 118 of throat portion 110 of the container portion 100, as seen most clearly in FIGS. 3 and 4.

Throat portion 120 extends from an opening 126, preferably arranged for non-removable sealing engagement with opening 112 of container portion 100, and terminates in a threaded mounting portion 128 which is arranged for removable and replaceable mounting thereon of frictional engagement portion 104.

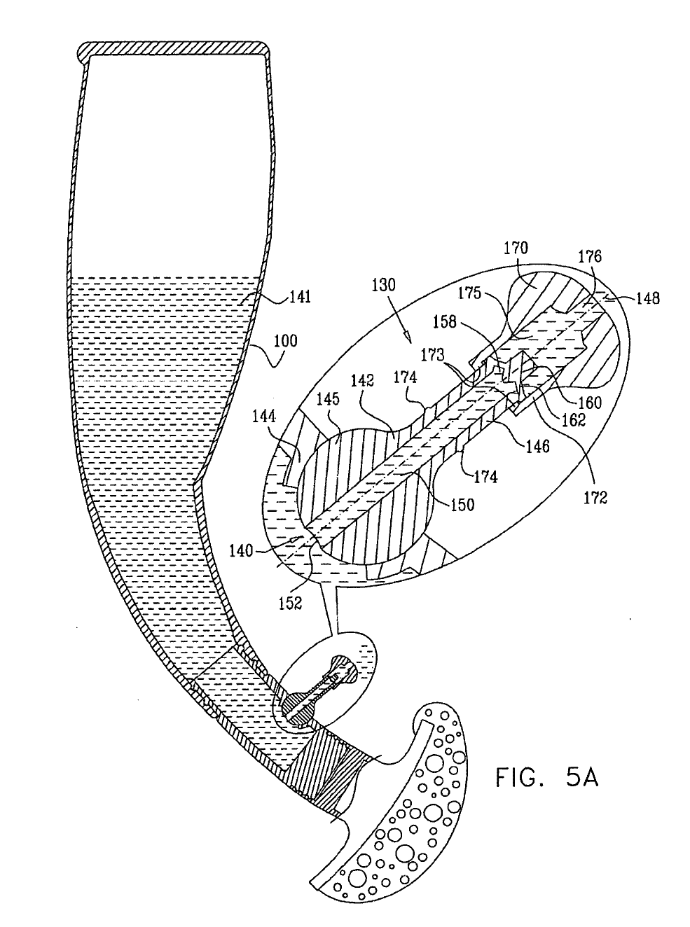

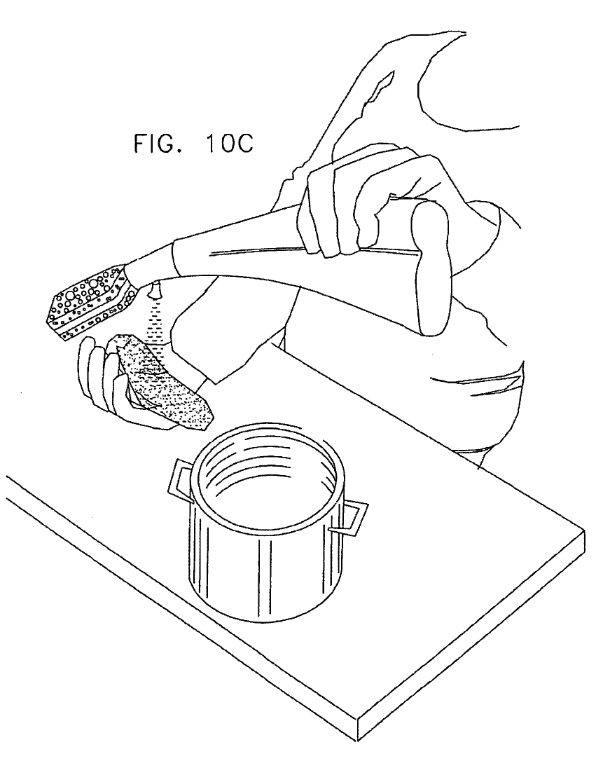

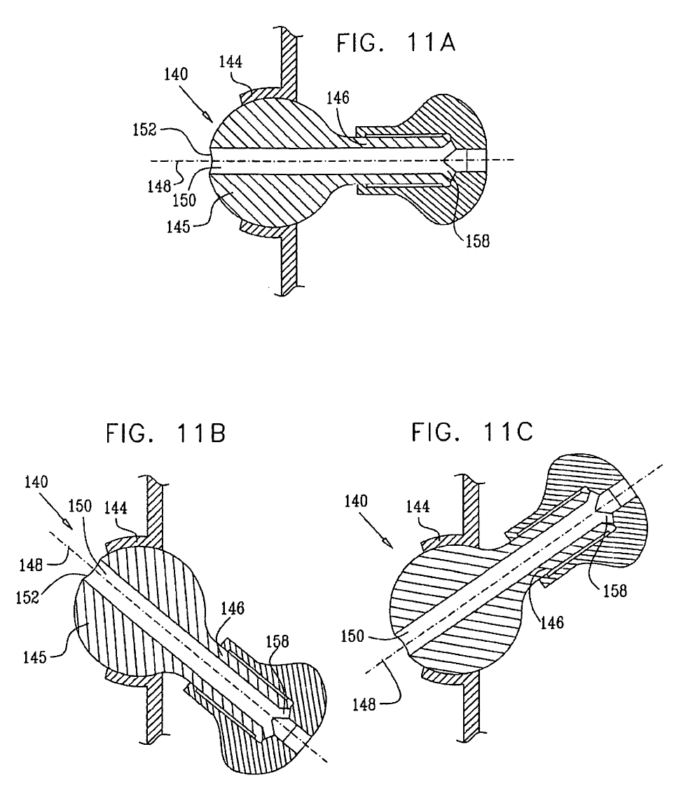

In accordance with a preferred embodiment of the present invention, a manually-controllable, selectably directable dispensing valve assembly 130 is provided on concave ventral surface 124 of dispensing portion 102 and is arranged to dispense a liquid, such as liquid soap, shower gel or any other suitable material, from the interior of container portion 100. A preferred embodiment of a selectably directable dispensing valve assembly 130 is illustrated in FIGS. 11A-11C in various open and closed operative orientations. The structure and operation of manually-controllable, selectably directable dispensing valve assembly 130 is described hereinbelow with reference to FIGS. 5A & 5B. It is appreciated that alternatively any other suitable dispensing valve assembly 130 may be employed.

Frictional engagement portion 104 preferably comprises a threaded mounting portion 132, which is arranged for removable and replaceable mounting onto threaded mounting portion 128 of dispensing portion 102. Frictional engagement portion 104 preferably includes a curved mounting surface 134 onto which a washing element 136 is adhered or otherwise attached. Curved mounting surface 134 is preferably arranged to extend generally perpendicularly to longitudinal axis 122, but more precisely may be curved about axes extending generally perpendicular to longitudinal axis 122 and to each other.

Washing element 136 is preferably a resilient, flexible and absorbent element, such as a sponge. Alternatively, washing element 136 may be any suitable washing element, such as a brush, a loofa and a grid. It is appreciated that multiple frictional engagement portions 104 may be provided for replaceable engagement with the dispensing portion 102, depending on a user's preferences and the intended use of the dispenser assembly.

It is a particular feature of the present invention that the interior of throat portion 120 does not communicate with the washing element 136, thereby eliminating the possibility of backflow of contaminating liquid from washing element 136 via the interior of throat portion 120 to the supply of liquid contained in container portion 100.

In accordance with a preferred embodiment of the present invention, the dispensing valve assembly 130 is sealingly mounted into an aperture 140 formed in the concave ventral surface 124 of dispensing portion 102 at a location spaced from washing element 136, such that normally, the liquid, such as liquid soap, shower gel or any other suitable material, dispensed from dispensing valve assembly 130 does not directly impinge on the washing element 136.

Preferably, the manually controllable dispensing valve assembly 130 communicates with the interior of throat portion 120 via aperture 140, which is disposed generally equidistant along ventral surface 124 between opening 126 and curved mounting surface 134. Manually controllable dispensing valve assembly 130 is preferably maintained in a closed position during storage and transport.

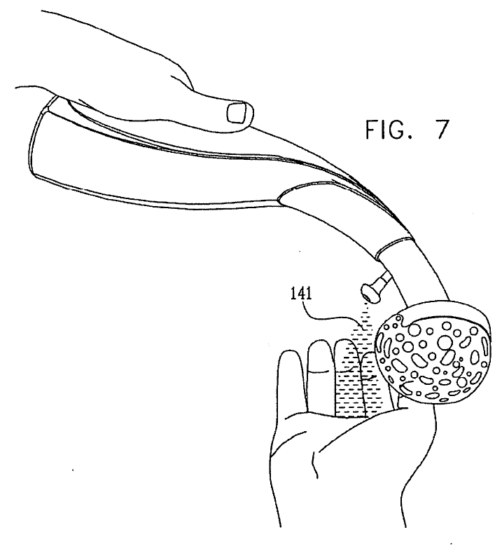

Preferably, manually controllable dispensing valve assembly 130 is spaced from curved mounting surface 134 by at least one inch, to enable a user to dispense liquid via manually controllable dispensing valve assembly 130 into his hand, when his hand underlies manually controllable dispensing valve assembly 130 and curved mounting surface 134, as seen in FIG. 7. It is preferred that the manually controllable dispensing valve assembly 130 be arranged so that a direction of outflow of liquid therefrom may be generally perpendicular to longitudinal axis 122 and more particularly generally perpendicular to curved mounting surface 134. More preferably, it is preferred that the dispensing valve assembly 130 be selectably directable by the user, as shown in FIGS. 11A-11C.

Manually controllable dispensing valve assembly 130 may be any suitable manually controllable dispensing valve assembly 130 and is preferably an outlet assembly having variable rate valve functionality, thus being operative to permit manual control of permitting and preventing the flow of liquid such as liquid soap, shower gel or any other suitable material, therethrough as well as manual control of the rate of dispensing the liquid therethrough. Preferably, manually-controllable dispensing valve assembly 130, when in an open operative orientation, allows dispensing of liquid, such as liquid soap, shower gel or other material of requisite viscosity, from the interior of container portion 100 only responsive to positive pressure produced by squeezing on the container portion 100 and not responsive only to the gravitation force produced by turning the container portion 100 upside down. This no-drip functionality is preferably based on the viscosity of the liquid and the size of the opening in the valve assembly 130.

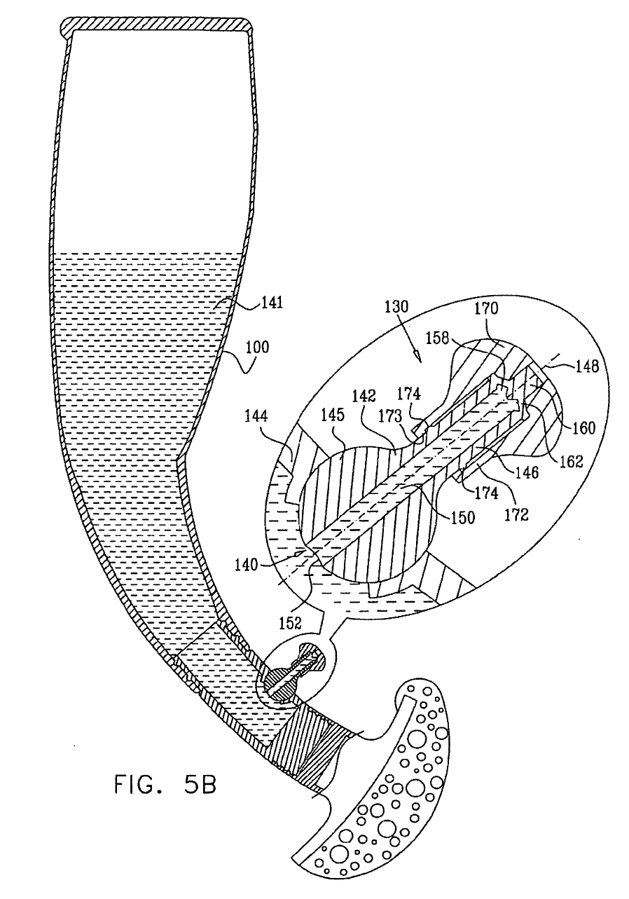

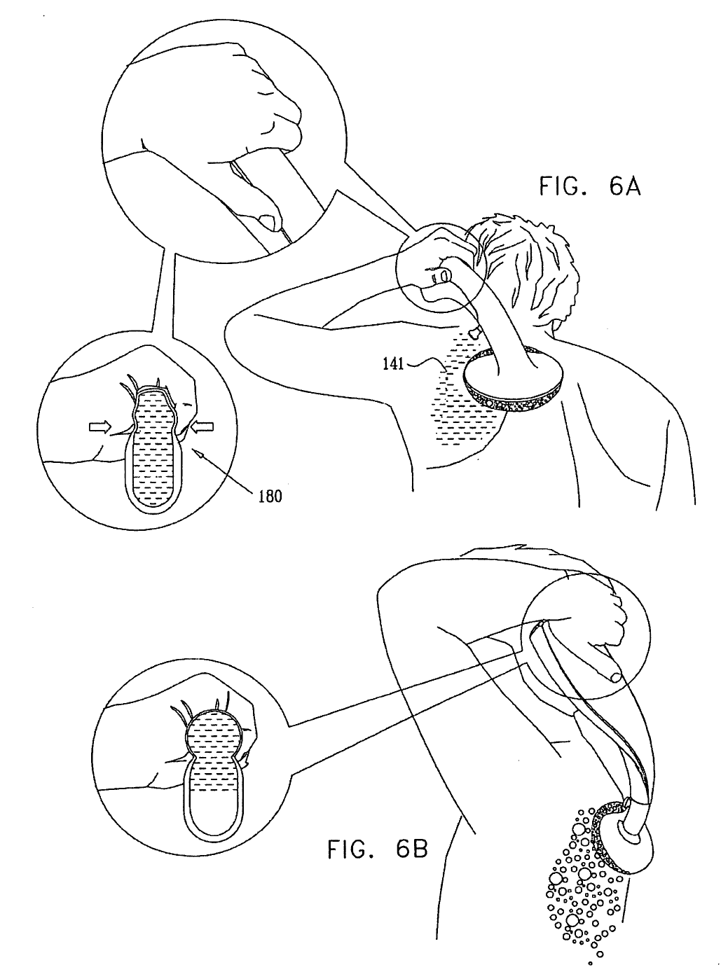

Reference is now made to FIGS. 5A and 5B, which are simplified illustrations of the operation of the dispenser assembly of FIGS. 1-4 in respective open and closed operative orientations and which illustrate the structure and operation of a preferred controllable dispensing outlet assembly, to FIGS. 6A, 6B and 7, which are simplified pictorial illustrations of uses of the dispenser assembly of FIGS. 1-5B, and to FIGS. 11A-11C, which illustrate various operative orientations of the manually-controllable dispensing valve assembly 130.

As seen in FIGS. 5A and 5B, a liquid 141, preferably liquid soap, is contained within container portion 100. The dispenser assembly is typically turned upside down when it is used for washing a person's back, as seen in FIG. 6A and 6B, or for dispensing soap into a person's hand, as seen in FIG. 7.

As seen in FIGS. 5A and 5B, and also with particularity in FIGS. 11A-11C, manually-controllable, selectably-directable dispensing valve assembly 130 includes a partially ball-type body 142, which is seated in a partial ball type seat 144 defined by aperture 140. Body 142 includes a generally spherical portion 145 and an elongate portion 146 extending outwardly therefrom along an axis 148. An elongate bore 150 extends through body 142 along axis 148 from an inlet 152 disposed interiorly of dispensing portion 102 and through elongate portion 146 to an outlet 158 adjacent a valve stem portion 160, which is mounted onto body 142 by support portions 162. A manually engageable valve locking element 170 is slidable along axis 148 relative to elongate portion 146 of body 142 and includes a cylindrical portion 172 having one or more resilient inwardly directed protrusion 173, which selectably engage corresponding protrusions 174 formed on elongate portion 146 of body 142 for locking the locking element 170 in a closed operative orientation relative to body 142.

Locking element 170 is formed with a relatively wide elongate bore 175 which extends through cylindrical portion 172 and terminates in a narrowed bore 176 which is sized to sealingly and slidably accept valve stem portion 160, when the locking element 170 is in a closed orientation relative to body 142, as shown, for example in FIGS. 5B and 11A-11C.

Opening of locking element 170 is achieved by manually actuated axial displacement of locking element 170 away firm spherical portion 144 along axis 148, resilient disengagement of protrusions 173 from protrusions 174 and disengagement of stem portion 160 from bore 176, allowing liquid, such as liquid soap, shower gel or other material of requisite viscosity, to pass from the interior of container portion 100 only in response to positive pressure produced by squeezing on the container portion 100, through bore 150, past valve stein portion 160 and through bore 176 to the outside.

Turning now to FIGS. 6A and 6B, it is seen with particularity that in accordance with a preferred embodiment of the present invention, the container portion 100 is preferably constructed to have a preferred squeezing portion 180 along dorsal surface 114 (FIGS. 1-4). Preferred squeezing portion 180 is preferably formed with thinner walls than the remainder of the container portion 100, along ventral surface 116. Thus, as seen in FIG. 6A, when a user wishes to dispense liquid 141, such as liquid soap, shower gel or other material of requisite viscosity, from the interior of container portion 100, he grasps the container portion 100 and exerts positive pressure on the preferred squeezing portion 180, as seen in enlargement A, thereby causing the liquid 141, such as liquid soap, shower gel or other material of requisite viscosity, to be dispensed from the interior of container portion 100.

When the user does not seek to dispense the liquid, he may grasp the container portion 100 in exactly the same way, but does not exert positive pressure on the preferred squeezing portion 180, as seen in FIG. 6B, and thus liquid, such as liquid soap, shower gel or other material of requisite viscosity, is not dispensed from the interior of container portion 100.

Turning now to FIG. 7, it is seen that liquid 141, such as liquid soap, shower gel or other material of requisite viscosity, may be dispensed from the interior of container portion 100 directly onto the palm of the hand of a user, which may be located underlying manually-controllable, selectably-directable dispensing valve assembly 130.

It is appreciated that curved mounting surface 134 and threaded mounting portion 132 of frictional engagement portion 104 are preferably formed of a resilient material to allow a user of die dispenser assembly to selectably position curved mounting surface 134 relative to manually-controllable dispensing valve assembly 130. Preferably, curved mounting surface 134 may be selectably positioned, by a user applying pressure, to allow dispensing valve assembly 130 to be positioned in close proximity to a body surface that the user wishes to apply liquid 141 thereon.

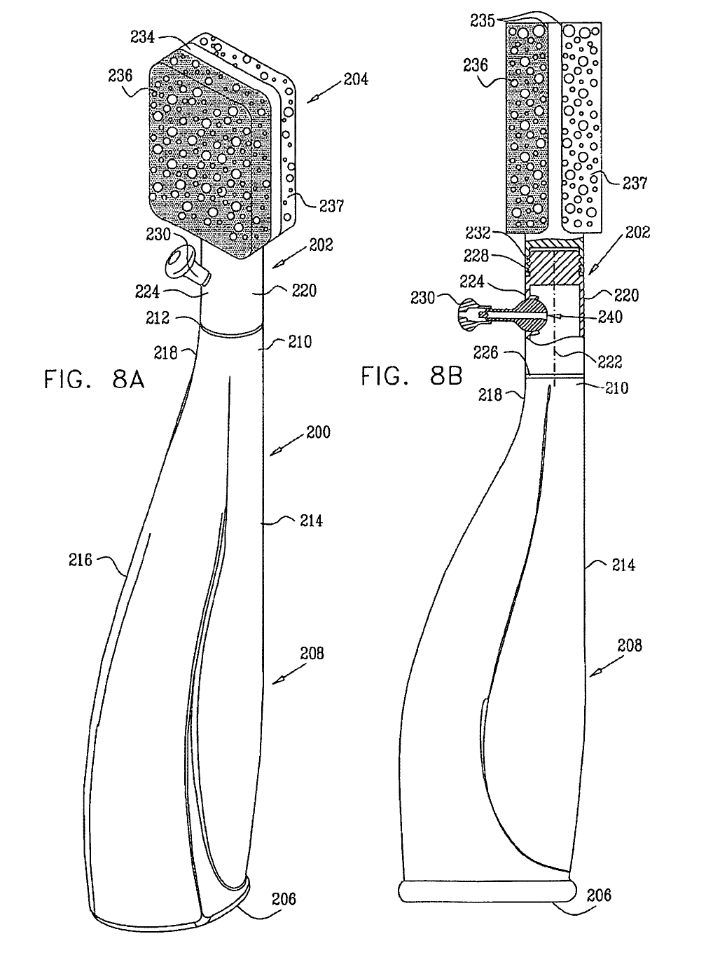

Reference is now made to FIGS. 8A and 8B, which are simplified illustrations of a dispenser assembly constructed and operative in accordance with another preferred embodiment of the present invention, particularly suitable for dishwashing but alternatively useful for any other washing function. As seen in FIGS. 8A & 8B, the dispenser assembly comprises a container portion 200, a dispensing portion 202 and a frictional engagement portion 204.

The container portion 200 is preferably formed with a flat bottom wall 206. Container portion 200 is generally upstanding and non-symmetric, having a main portion 208 extending upwardly from bottom wall 206 and terminating in a throat portion 210 having an opening 212 configured for sealing engagement with the dispensing portion 202 after filling of main portion 208 with liquid soap, shower gel or any other suitable material.

Main portion 208 and throat portion 210 preferably are configured to have a generally straight dorsal surface 214 which extends along both main portion 208 and throat portion 21.0, generally from bottom wall 206 to opening 212. Main portion 208 has a generally convex ventral surface 216, which extends generally from bottom wall 206 to throat portion 210. A ventral surface 218 of throat portion 210 has a generally concave curvature extending from the main portion 208 to opening 212. Opening 212 is preferably configured for ease of automated filling with a liquid such as liquid detergent or any other suitable material, and subsequent sealing engagement with dispensing portion 202.

The dispensing portion 202 is configured to have a generally elongated throat portion 220 which is arranged about a longitudinal axis 222.

Throat portion 220 extends from an opening 226, preferably arranged for non-removable scaling engagement with opening 212 of container portion 200, and terminates in a threaded mounting portion 228 which is arranged for removable and replaceable mounting thereon of frictional engagement portion 204.

In accordance with a preferred embodiment of the present invention, a manually-controllable, selectably directable dispensing valve assembly 230 is provided on a ventral surface 224 of dispensing portion 202 and is arranged to dispense a liquid, such as liquid detergent, from the interior of container portion 200. A preferred embodiment of a selectably directable dispensing valve assembly 230 is illustrated in FIGS. 11A-11C in various open and closed operative orientations. The structure and operation of manually-controllable, selectably directable dispensing valve assembly 230 is described hereinabove with reference to FIGS. 5A and 5B. It is appreciated that alternatively any other suitable dispensing valve assembly 230 may be employed.

Frictional engagement portion 204 preferably comprises a threaded mounting portion 232, which is arranged for removable and replaceable mounting onto threaded mounting portion 228 of dispensing portion 202. Frictional engagement portion 204 preferably includes a double sided mounting element 234 having opposite facing mounting surfaces 235 onto which are mounted one or more washing elements, here shown as elements 236 and 237.

Washing elements 236 and 237 are preferably formed of different materials or otherwise manufactured to have different surface characteristics. For example, washing element 236 may be a combination sponge scrubber while washing element 237 may be a sponge. Alternatively, washing elements 236 and 237 may be any suitable washing elements, such as a brush, a loofa and a grid. It is appreciated that multiple frictional engagement portions 204 may be provided for replaceable engagement with the dispensing portion 202, depending on a user's preferences and the intended use of the dispenser assembly.

It is a particular feature of the present invention that the interior of throat portion 220 does not communicate with the washing elements 236 and 237, thereby eliminating the possibility of backflow of contaminating liquid from washing element 236 or 237 via the interior of throat portion 220 to the supply of liquid contained in container portion 200.

In accordance with a preferred embodiment of the present invention, the dispensing valve assembly 230 is sealingly mounted into an aperture 240 formed in the ventral surface 224 of dispensing portion 202 at a location spaced from washing element 236, such that normally, the liquid, such as liquid detergent, or any other suitable material, dispensed from dispensing valve assembly 230 does not directly impinge on the washing element 236.

Preferably, the manually controllable dispensing valve assembly 230 communicates with the interior of throat portion 220 via aperture 240, which is disposed generally equidistant along ventral surface 224 between opening 226 and the top of threaded mounting portion 228. Manually controllable dispensing valve assembly 230 is preferably maintained in a closed position during storage and transport.

Manually controllable dispensing valve assembly 230 may be any suitable manually controllable dispensing valve assembly 230 and is preferably an outlet assembly having variable rate valve functionality, thus being operative to permit manual control of permitting and preventing the flow of liquid, such as liquid detergent or any other suitable material, therethrough as well as manual control of the rate of dispensing the liquid therethrough. Preferably, manually-controllable dispensing valve assembly 230, when in all open operative orientation, allows dispensing of liquid, such as liquid detergent or other material of requisite viscosity, from the interior of container portion 200 only responsive to positive pressure produced by squeezing on the container portion 200 and not responsive only to the gravitation force produced by turning the container portion 200 upside down. This no-drip functionality is preferably based on the viscosity of the liquid and the size of the opening in the valve assembly 230.

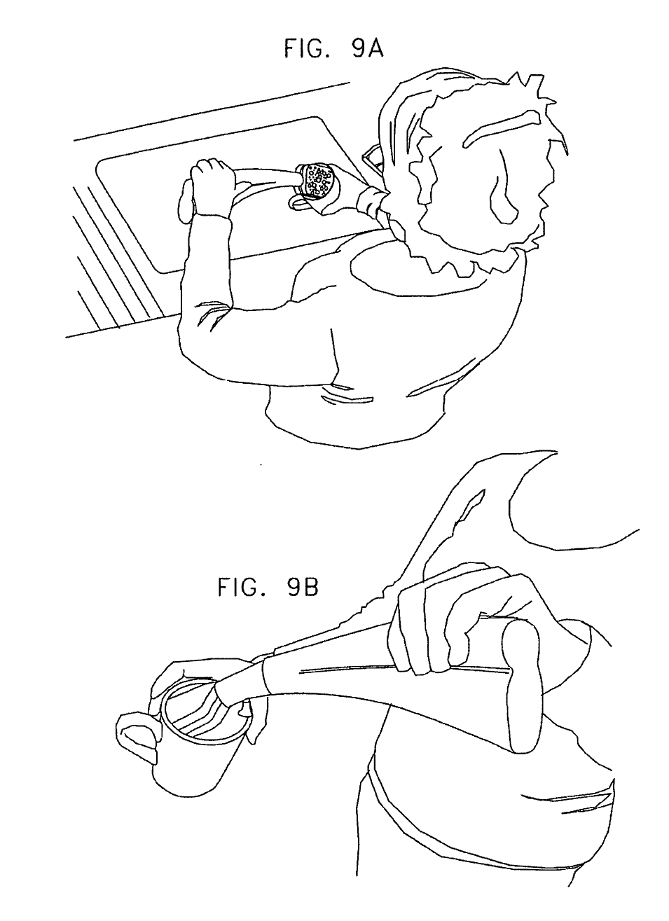

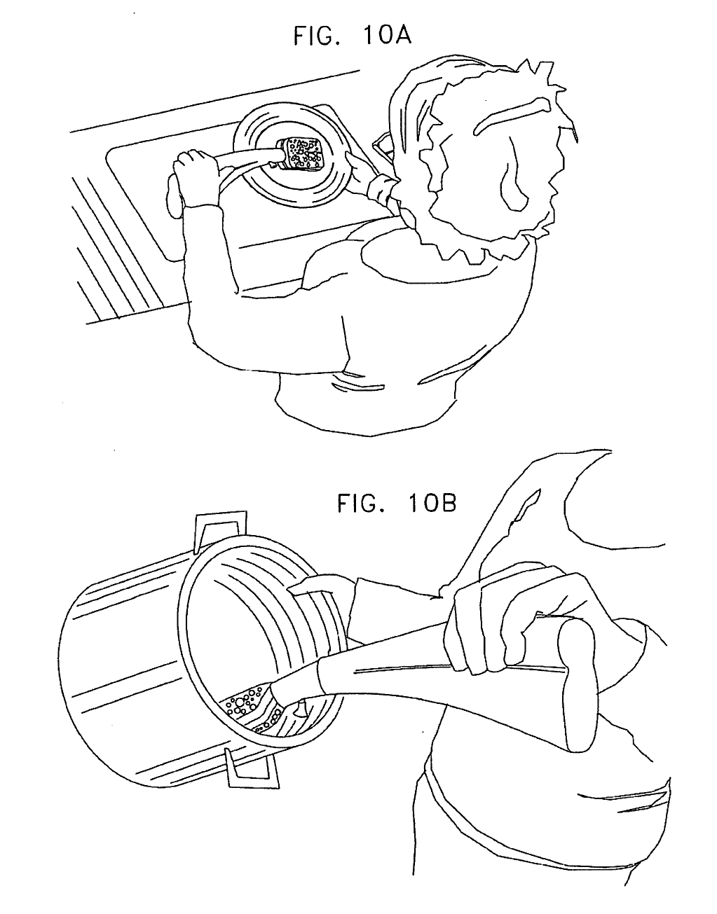

Reference is now made to FIGS. 9A & 9B which illustrate use of the dispenser assembly of FIGS. 8A & 8B for washing a cup. FIG. 9B shows dispensing of liquid detergent directly into the cup from the dispenser assembly as the cup is being washed using the dispenser assembly. FIGS. 10A and 10B show the possibility of dispensing liquid detergent from the dispenser assembly of FIGS. 8A & 8B while washing a dish or pot. FIG. 10C shows dispensing liquid detergent from the dispenser assembly of FIGS. 8A & 8B onto a separate cleaning utensil.

It will be appreciated by persons skilled in the art that the present invention is not limited by what has been particularly shown and described hereinabove. Rather the scope of the present invention includes both combinations and subcombinations of various features described hereinabove as well as modifications and variations thereof which would occur to a person skilled in the art upon reading the foregoing description and which arc not in the prior art.

1. A dispenser assembly comprising:
a container portion, and
a dispensing and frictional engagement assembly, arranged for sealing engagement with said container portion, said dispensing and frictional engagement assembly comprising a resilient, flexible washing engagement portion and a manually controllable dispensing outlet assembly arranged to dispense a liquid from said container portion at a location spaced from said resilient flexible washing engagement portion, said resilient flexible washing engagement portion being isolated from the interior of said container portion whereby backflow of liquid from said flexible washing engagement portion normally is prevented from entering said interior of said container portion.

2. A dispenser assembly according to claim 1 and wherein said dispensing outlet assembly is configured and located such that liquid dispensed therefrom does not directly impinge on said flexible washing engagement portion.

3. A dispenser assembly according to claim 1 and wherein said dispensing outlet assembly comprises a selectably directable dispensing outlet assembly.

4. A dispenser assembly according to claim 3 and wherein said dispensing outlet assembly comprises a manually-controllable valve.

5. A dispenser assembly according to claim 1 and wherein said dispensing and frictional engagement assembly comprises a dispensing portion and a frictional engagement portion.

6. A dispenser assembly according to claim 5 and wherein said dispensing portion includes a first connector portion arranged for fixed, sealing engagement with said container portion following automated filling thereof and a second connection portion arranged for removable and replaceable engagement with said frictional engagement portion, said first and second connection portions not being in fluid communication with each other.

7. A dispenser assembly according to claim 6 and wherein said dispensing portion includes said manually controllable dispensing outlet assembly and said frictional engagement portion includes said resilient, flexible washing engagement portion.

8. A dispenser assembly according to claim 5 and wherein said frictional engagement portion comprises a resilient mounting surface,

9. A dispenser assembly according to claim 1 and wherein said dispensing and frictional engagement assembly includes a neck section having an engagement portion arranged for said removable and replaceable sealing engagement with said container portion and a forward mounting portion for mounting thereon of said resilient, flexible washing engagement portion, said manually controllable dispensing outlet assembly being disposed along said neck section intermediate said engagement portion and said forward mounting portion.

10. A dispenser assembly according to claim 9 and wherein said forward mounting portion extends generally perpendicular to said longitudinal axis of said neck portion.

11. A dispenser assembly according to claim 1 and wherein said manually controllable dispensing outlet assembly is arranged to as to dispense said liquid in a direction generally perpendicular to a longitudinal axis of said neck portion.

12. A dispenser assembly according to claim 1 and wherein said manually controllable dispensing outlet assembly is operative to permit manual control of opening and closing said outlet as well as manual control of the rate of dispensing said liquid.

13. A dispenser assembly according to claim 1 and wherein said container portion comprises a bottom wall portion and first and second generally upstanding container wall portions extending upwardly from said bottom wall portion, said first container wall portion having a first wall thickness and said second container wall portion having a second wall thickness different from said first wall thickness.

14. A dispenser assembly according to claim 13 and wherein said first container wall portion extends alongside said second wall portion, generally perpendicularly to said bottom wall portion.

15. A dispenser assembly according to claim 13 and wherein said first container wall portion extends alongside a dorsal surface of said container portion and said second container wall portion extends along a ventral surface of said container portion and said first wall thickness is less than said second wall thickness.

16. A dispenser assembly comprising:
a container portion including a bottom wall portion and first and second generally upstanding container wall portions extending upwardly from said bottom wall portion, said first container wall portion having a first wall thickness and said second container wall portion having a second wall thickness different from said first wall thickness; and
a dispensing portion, arranged for engagement with said container portion.

17. A dispenser assembly according to claim 16 and wherein said fist container wall portion extends alongside said second wall portion, generally perpendicularly to said bottom wall portion.

18. A dispenser assembly according to claim 16 and wherein said first container wall portion extends alongside a dorsal surface of said container portion and said second container wall portion extends along a ventral surface of said container portion and said first wall thickness is less than said second wall thickness.

19. A dishwashing utensil comprising:
a container portion; and
a dispensing and frictional engagement assembly, arranged for sealing engagement with said container portion, said dispensing mad frictional engagement assembly comprising a resilient, flexible dishwashing engagement portion and a manually controllable dispensing outlet assembly arranged to dispense a liquid from said container portion at a location spaced from said resilient flexible washing engagement portion, said resilient flexible washing engagement portion being isolated from the interior of said container portion whereby backflow of liquid from said flexible washing engagement portion normally is prevented from entering said interior of said container portion.

20. A dishwashing utensil according to claim 19 and wherein said dispensing outlet assembly is configured and located such that liquid dispensed therefrom is directed onto a an item while it is being washingly engaged by said resilient, flexible dishwashing engagement portion.

21. A dishwashing utensil according to claim 19 and wherein said dispensing outlet assembly comprises a selectably directable dispensing outlet assembly.
